(19) United States
(12) Patent Application Publication
(10) Pub. No.: US 2020/0023373 A1
(43) Pub. Date: Jan. 23, 2020

(54) DISCHARGE END WALL SYSTEM INCLUDING PARTIALLY CURVED PULP LIFTERS

(71) Applicant: Polycorp Ltd., Elora (CA)

(72) Inventors: Robert Michael McPhee, Burlington (CA); Pramod Kumar, Waterloo (CA)

(73) Assignee: Polycorp Ltd., Elora (CA)

(21) Appl. No.: 16/511,140

(22) Filed: Jul. 15, 2019

Related U.S. Application Data
(60) Provisional application No. 62/699,826, filed on Jul. 18, 2018.

(51) Int. Cl. B02C 17/18

(52) U.S. Cl. CPC B02C 17/1855; B02C 17/1825

(57) ABSTRACT

A discharge end wall system mounted on a discharge end wall in a grinding mill. The discharge wall system includes a discharge end assembly that has a number of pulp lifter segments radially arranged on the discharge end wall relative to the axis of rotation, and a number of curved walls connected with the pulp lifter segments and arranged in pairs of adjacent ones thereof. Each trailing one of the curved walls has a curved leading edge surface that is concave in relation to the direction of rotation and, with a leading edge surface of a selected leading one of the pulp lifter segments, forms a continuous leading wall that is partially straight and partially curved. The leading wall is configured to accelerate pulp through the pulp chamber partially thereby defined respectively to a central hole, when the pulp chamber partially defined thereby is in the discharge condition thereof.

### CROSS-REFERENCE TO RELATED APPLICATION

This application claims the benefit of U.S. Provisional Patent Application No. 62/699,826, filed on Jul. 18, 2018, the entirety of which is hereby incorporated herein by reference.

### FIELD OF THE INVENTION

The present invention is a discharge end wall system including partially curved pulp lifters.

### BACKGROUND OF THE INVENTION

As is well known in the art, various elements of a grinding mill typically are subjected to wear in characteristic patterns, in which certain surfaces of certain elements are subjected to greater wear than other surfaces.

As can be seen in FIGS. 1A-1E, a conventional discharge wall assembly 20 in a typical grinding mill 21 (FIG. 1E) includes a number of vanes or pulp lifters 22 (FIGS. 1A-1D) that extend inwardly toward a central hole 24 from a shell wall or outer perimeter wall 26 of a mill shell 23 (FIG. 1E). The vanes or pulp lifters 22 are at least partially mounted on a discharge end wall 27 (FIGS. 1A, 1E). The pulp lifters 22 are intended to direct pulp that includes ore particles and water through pulp chambers 28 to the central hole 24, through which the pulp exits the grinding mill 21. In the example illustrated in FIGS. 1A-1D, the vanes 22 include shorter and longer vanes. As is well known in the art, various arrangements of longer and shorter vanes, and possibly additional vanes of longer or shorter or intermediate length (not shown in FIGS. 1A-1D), may be used. The optimum design depends on a number of parameters, e.g., the hardness of the ore, and the cost of energy inputs, as is also known.

As is well known in the art, the vanes or pulp lifters 22, the outer perimeter wall 26, and the discharge end wall 27, at least partially define the pulp chambers 28 therebetween. Each pulp chamber is located between a leading pulp lifter and a trailing pulp lifter, relative to the direction of rotation. Typically, when the grinding mill is in use, discharge grates “DG” (FIG. 1E) are located on the pulp chambers 28 and include apertures to screen the flow of slurry or pulp into the pulp chambers, i.e., to limit the solid particles in the slurry or pulp entering the pulp chambers to particles sized smaller than the apertures in the grates. The discharge grates “DG” also partially define the respective pulp chambers.

The discharge grates are omitted from FIGS. 1A-1D for clarity of illustration. The location where a discharge grate “DG” would be positioned (i.e., over an outer portion “OP” of a pulp chamber) is illustrated in FIG. 1A. It will be understood that blind plates “BP” are also located on each pulp chamber, and these blind plates are located radially inwardly from the discharge grates. The blind plates “BP” each cover an inner portion “IP” of the pulp chamber. The location of the blind plate “BP” is indicated in FIG. 1A.

Those skilled in the art would appreciate that the prior art discharge grates “DG” that are located on the prior art pulp lifters are formed with linear (i.e., straight) sides that are located radially relative to the axis of rotation, and aligned with the prior art pulp lifters, to permit conveniently securing the discharge grates along their radially-positioned sides to the pulp lifters. This configuration permits relatively rapid assembly and replacement.

It will also be understood that the majority of the solid particles in the pulp (i.e., primarily ore that has been ground), which exit the pulp chambers via the central hole 24, are omitted from FIGS. 1A-1E for clarity of illustration. As is well known in the art, the slurry or pulp is a heterogeneous mixture of solid particles and water. Some finer particles may be suspended in the water. The ore and the ore particles typically include some waste material.

As is well known in the art, the mill shell 23 of the grinding mill 21 defines a mill shell chamber 25 upstream from the pulp chambers, and the mill shell 23 is rotatable about an axis of rotation “AX” (FIG. 1E). When the grinding mill is operating, a charge (identified in FIG. 1E by the reference character “CH”) is located in the mill shell chamber 25. The charge (i.e., ore, water, and grinding media, if grinding media are used) may fill the mill shell chamber up to a level indicated by a line “A” in FIGS. 1A and 1C-1E. The direction of rotation of the mill shell 23 is indicated by arrow “B” in FIGS. 1A-1D.

Typically, the ore is added into the grinding mill at an input end (as schematically represented by arrow “IN” in FIG. 1E), and water is also added into the mill shell chamber 25 of the grinding mill 21. The charge is rotated as the mill shell of the grinding mill rotates, subjecting the ore to comminution and resulting in finely-ground ore particles that are included in the slurry or pulp that is passed to an output, or discharge, end of the grinding mill. The movement of the ore particles and water through the discharge grates “DG” and into the pulp chambers is schematically represented by arrows “OPW” in FIG. 1E. From the foregoing, it can be seen that, as the mill shell 23 rotates, the pulp chambers 28 are also rotated.

It will be understood that the top surface of the charge (identified as “A” in FIGS. 1A and 1C-1E) may vary significantly, depending on a number of parameters, and the level illustrated in FIGS. 1A and 1C-1E is exemplary only. (As will be described, embodiments of the invention are illustrated in the balance of the attached drawings.) It will also be understood that the direction of rotation may be clockwise or counter-clockwise, depending on how the mill is manufactured and installed. The selection of a clockwise direction of rotation, as illustrated in FIGS. 1A-1D, is arbitrary, and is made for the purpose of illustration.

Ideally, each respective pulp chamber would be completely vacated due to gravity while the pulp chamber is located above the charge. This would mean that, in an ideal situation, each of the pulp chambers would be vacated prior to their respective immersions in the charge, in each rotation of the mill shell. As will be described, however, in the prior art, “carryover” of pulp (some pulp remaining in the pulp chamber when the pulp chamber is re-immersed in the charge) frequently imposes increased costs.

As each of the pulp chambers is immersed in the charge in turn, the slurry flows into each pulp chamber successively. As can be seen in FIGS. 1A-1D, depending on the amount of the charge in the mill shell chamber, a pulp chamber may be immersed (in whole or in part) as it is rotated from about the three o'clock position to about the nine o'clock position, when the rotation is clockwise.

Once the respective pulp chambers are raised above the charge, each of the pulp chambers is at least partially emptied, as they are moved in the direction indicated by arrow “B”. In the example illustrated in FIGS. 1A-1D, as a particular pulp chamber is moved from about the nine o'clock position to about the three o'clock position (i.e., when it is located above the line designated “A”), the pulp in that pulp chamber is directed by gravity generally toward the central hole by the vanes or pulp lifters that partially define that pulp chamber (i.e., one such vane being located on each side of the pulp chamber). In the prior art, however, not all of the pulp is vacated from the pulp chambers, resulting in “carryover”, i.e., pulp that remains at least temporarily in the pulp chamber, for more than one rotation thereof.

The vanes or pulp lifters also support the pulp that is positioned on them respectively, and direct the pulp generally toward the central hole, when the vanes are rotated clockwise from approximately the nine o'clock position to approximately the three o'clock position. The movement of the pulp from the pulp chambers and into the central hole 24 is schematically represented by arrow “EX” in FIG. 1E.

The elements engaged by the pulp as the pulp moves in the pulp chambers are thereby subjected to wear. However, significant wear results from the pulp that is “carried over”. As is known in the art, due to the concentration of wear on certain surfaces of certain elements in the discharge wall assembly due to carryover, such elements may need to be replaced, even though other parts of the elements have been subjected to relatively little wear. As a result, because of carryover, significant costs may be incurred due to excessive wear that is concentrated in a relatively small area of a surface of an element.

First, costs are incurred in connection with purchasing a new element or component, e.g., all or part of a vane or pulp lifter. Second, costs are also incurred in connection with the replaced element, e.g., although the replaced element may be worn in only a small portion thereof, it is prematurely replaced, as other portions of the elements may not be worn out. Third, and most important, significant costs are incurred due to the downtime required to replace an element that is prematurely worn.

The characteristic movements of certain of the ore particles in the pulp in the pulp chambers are illustrated in FIGS. 1A-1D. It is believed that at least some of the wear to which the elements forming the pulp chambers is subjected is due to the movement of “carryover” pulp.

As noted above, ideally, the pulp chamber should be fully emptied before it is next re-immersed in the charge. However, in practice, it often happens that a significant portion of the pulp does not exit the pulp chamber by the time that the pulp chamber has reached the three o'clock position, assuming a clockwise direction of rotation. The pulp remaining in the pulp chamber, at a point when it ideally all should have been discharged to the central hole, is typically referred to as “carryover”.

“Carryover” of pulp in grinding mills (i.e., the incomplete discharge of pulp in pulp chambers within one revolution of a mill shell) is a serious problem. It is believed that the extent of carryover may be as high as 50% of capacity or more, depending on the circumstances. Carryover imposes many costs on the operator, as noted above. In particular, it appears that some of the wear to which the elements mounted on the discharge end wall are subjected is due to carryover.

The movement of the pulp that is carried over is schematically illustrated in FIGS. 1A-1D. It will be understood that the illustrations in FIGS. 1A-1D are based on computer-generated graphic simulations of the movement of the pulp in the pulp chambers as the mill shell rotates.

The reasons for carryover are well-known in the art. The mill shell may be, for example, about 40 feet in diameter. The relatively high mill shell rotation speed, e.g., about 10 rpm, is an important factor. This relatively fast rotation speed means that the discharge wall 27 completes one rotation every six seconds. Accordingly, the pulp in a particular pulp chamber has only approximately three seconds, at most, to exit the pulp chamber 28, i.e., to be moved to the central hole 24, through which it may exit. In addition, due to the rotation of the mill shell, the pulp in each pulp chamber is urged outwardly by centrifugal force, i.e., away from the central hole 24, effectively slowing the exit of the pulp from the pulp chamber as the pulp chamber moves from approximately the nine o'clock position to approximately the three o'clock position, if rotating clockwise. It is believed that carryover is the consequence of there being insufficient time allowed for full evacuation of the pulp chambers.

It has been determined that the movement of the pulp that is carried over, inside the pulp chamber, is distinctive to the specific grinding mill, and generally consistent. In general, because the pulp that is “carried over” in a particular pulp chamber typically is located on a trailing side of the leading pulp lifter for that pulp chamber for a short period of time in every rotation, the trailing sides of the pulp lifters are thereby subjected to more wear than other elements of the discharge wall assembly 20. As will be described, for a short time while the carried-over pulp is supported by and engaged with the trailing side of the leading pulp lifter, the carried-over pulp is also moved relative to the trailing side, i.e., the carried-over pulp tends to shift while supported by the trailing side. However, the wear is not necessarily uniform over different pulp chambers in a particular mill, for reasons that are unclear.

For example, in FIG. 1A and FIG. 1B, pulp chambers identified for convenience by reference numerals 28A-28E are shown with ore particles 30 of the pulp therein. (It will be understood that only a portion of the ore particles that are in the pulp are illustrated in FIGS. 1A-1D, and the sizes of the ore particles 30 are exaggerated, for clarity of illustration. Also, the water in the pulp is omitted from FIGS. 1A-1D, for clarity of illustration.) As can be seen in FIGS. 1A and 1B, as an example, pulp chamber 28A is partially defined between a pair of the vanes or pulp lifters identified for convenience by reference numerals 122 and 122A, which are the trailing and leading pulp lifters respectively for the pulp chamber 28A, relative to the direction of rotation. As illustrated, when the pulp chamber 28A is approximately in the one o'clock position, the solid particles 30 start to fall from a leading side 132 of the pulp lifter 122 (FIG. 1B).

In pulp chamber 28B, partially defined between a pair of the vanes identified in FIGS. 1A and 1B for convenience as 122A and 122B, the movement of the solid particles 30 toward a trailing side 134B of the leading vane 122B (for pulp chamber 28B) is more pronounced, because the pulp chamber 28B as illustrated is further along in the clockwise rotation than the pulp chamber 28A. (It will be understood that of the pair of the pulp lifters that define the pulp chamber 28B, the pulp lifter 122A is the trailing pulp lifter, and the pulp lifter 122B is the leading pulp lifter.) It will be understood that, immediately before the pulp lifter 122A was located approximately at the one o'clock position, at least some of the particles 30 would have been positioned on the leading side 132A of the trailing pulp lifter 122A (FIG. 1B).

In FIGS. 1A, 1B, and 1C, pulp chambers 28C, 28D, and 28E show the solid particles 30 progressively moved further onto the trailing side of the leading pulp lifter in each pulp chamber respectively, due to the changing positions of the respective pulp lifters relative to the vertical as the mill shell rotates, and due to the effects of gravity on the ore particles 30. In particular, in FIGS. 1A, 1B, and 1C, it can be seen that, in the pulp chambers 28D, 28E (located at the three o'clock position, or almost at such position) the ore particles 30 that will be carryover are positioned in a middle or intermediate area 35 of the trailing side of the leading pulp lifter. As can be seen in FIG. 1B, the ore particles 30 that are to be carried over are spaced apart from the shell wall 26 by a distance 36 (FIG. 1B).

As can be seen in FIG. 1D, the carried-over ore particles 30 move downwardly, to pile on the outer perimeter wall 26, when the pulp chambers are at or close to the six o'clock position. Those skilled in the art would also appreciate that the slurry that flows into the pulp chambers, to fill them when the pulp chambers are positioned below the surface of the charge, is also omitted from FIGS. 1A-1D, for clarity of illustration. It will be understood that, although omitted, the pulp (the ore particles and water) quickly fill the immersed pulp chambers, once the pulp chambers are re-immersed in the charge.

Those skilled in the art would also appreciate that, to the extent that the pulp chamber is occupied by the “carried-over” pulp, the pulp chamber would be unable to receive the pulp that otherwise may have flowed therein while the pulp chamber is immersed. Accordingly, carryover also negatively affects throughput. Carryover also requires higher energy consumption, because the carried over pulp is required to be rotated.

It can be seen in FIGS. 1A-1D that, although the solid particles 30 in a particular pulp chamber have been moved part of the distance toward the central hole when the pulp chambers are at approximately the three o'clock position or prior thereto (when rotation is clockwise), the particles 30 that are illustrated as carryover do not reach the central hole.

The particles 30 that are destined to become carryover in the example illustrated in FIGS. 1A-1D are, at one point while the mill shell rotates, generally located in the middle area 35 of the trailing side of the pulp lifter, i.e., they are temporarily located a relatively short distance from the central hole. In FIGS. 1A, 1B, and 1C, it can be seen that the particles 30 have moved from the leading side of the trailing pulp lifter to the middle area 35 of the trailing side of the leading pulp lifter as the pulp chamber 28 in which the particles 30 are located has moved from approximately the nine o'clock position to approximately the three o'clock position. However, because the particles 30 that are illustrated have not reached the central hole 24 when the pulp chamber they are in is at approximately the three o'clock position, they are returned to engage the outer perimeter wall 26 as the pulp chamber in which they are located moves further (clockwise, as illustrated in FIGS. 1A-1D) from approximately the three o'clock position. For these particles 30, the gains achieved during this rotation (i.e., the distances moved toward the central hole) are lost when the pulp chamber moves past the three o'clock position.

It will also be appreciated that the carried-over solid particles 30 move to the outer wall 26 when the pulp chamber(s) in which they are located is next re-immersed in the charge, as illustrated in FIG. 1D. The carried-over ore particles 30 will only exit the mill (i.e., via the central hole 24) in the next rotation if such solid particles reach the central hole during such rotation. Accordingly, it can be seen that some of the pulp that is carried over to the subsequent rotation may be carried over for several rotations.

In FIGS. 1A-1D, it can also be seen that the carryover of the ore particles 30 results in increased wear on certain portions of the pulp lifters 22, and also on the shell wall 26. For instance, as illustrated in FIGS. 1A and 1B, when the pulp lifter 122 is just past the vertical position (i.e., the twelve o'clock position), the solid particles 30 of the carryover fall from the leading side 132 of the pulp lifter 122, and it will be understood that many of such particles 30 engage the trailing side 134A of the adjacent (leading) pulp lifter 122A. In this way, the middle area 35 of the trailing side of each leading pulp lifter is subjected to wear due to the ore particles 30 that are carried over, in particular by the sliding movement of the ore particles 30 on the middle area 35.

The trailing side of each of the pulp lifters is subjected to impact (or dynamic) loading of the ore particles 30 onto the trailing side of the pulp lifter, at a location on the trailing side generally identified as “I” in FIG. 1B. Such dynamic loading occurs when the pulp lifter is located approximately at the one o'clock position to the two o'clock position, in a clockwise rotation. As illustrated in FIG. 1B, for example, the trailing side 134B of the leading pulp lifter 122B is subjected to dynamic loading when the pulp lifter 122B is approximately at the two o'clock position.

The positions of the carried-over ore particles 30 shift inside the pulp chamber 28 as the mill shell rotates. As can be seen in FIG. 1D, the solid particles 30 that are carried over tend to accumulate in the pulp chamber 28 on the outer perimeter wall 26, when the pulp chamber 28 is at or near the six o'clock position. (As noted above, other ore particles included in the pulp entering into the pulp chambers when they are immersed in the charge are omitted from FIGS. 1A and 1C-1D for clarity of illustration.) The portions “D₁”, “D₂” of the pulp lifters partially defining the pulp chamber that are proximal to the mill shell wall 26 may also be subjected to wear due to carryover, as are the portions “E” of the outer perimeter wall of the mill shell (FIG. 1D) that partially define the pulp chamber 28.

In FIG. 1B, certain ore particles that are not destined to be included in carryover are also illustrated, identified by the reference numeral 31. The ore particles 31 move downwardly toward the central hole 24, as schematically represented by arrows “J” in FIG. 1B. However, due to the lengths of certain pulp lifters, those pulp lifters are subjected to impact loading of the ore particles onto the trailing sides of the pulp lifters, at locations on the trailing sides identified as “K” in FIG. 1B. Accordingly, as illustrated in FIG. 1B, the longer pulp lifters may also be subjected to excess wear proximal to their respective inner ends, at “K”.

### SUMMARY OF THE INVENTION

There is a need for a discharge wall insert that overcomes or mitigates one or more of the defects or disadvantages of the prior art. Such disadvantages or defects are not necessarily included in those listed above.

In its broad aspect, the invention provides a discharge end wall system mounted on a discharge end wall of a mill shell in a grinding mill. The mill shell is rotatable about an axis of rotation thereof in a direction of rotation to produce a pulp including ore particles and water. The discharge end wall is partially defined by an outer perimeter wall of the mill shell and includes a central hole through which the pulp exits the mill shell. The discharge wall system includes a discharge end assembly that includes a number of pulp lifter segments radially arranged on the discharge end wall relative to the axis of rotation. The pulp lifter segments are arranged in pairs of adjacent ones thereof, each pair respectively including a leading one of the pulp lifter segments in the pair and a trailing one of the pulp lifter segments in the pair relative to the direction of rotation. A trailing edge surface of the leading one of the pulp lifter segments and a leading edge surface of the trailing one of the pulp lifter segments partially define inner portions of respective pulp chambers therebetween through which the pulp is at least partially directed to the central hole, when the pulp chambers are in discharge conditions thereof respectively, in which the pulp exits therefrom. Each pulp lifter segment extends between an inner end thereof located proximal to the central hole, and an outer end thereof spaced apart from the outer perimeter wall. The discharge end assembly also includes a number of curved walls arranged in pairs of adjacent ones thereof, each pair respectively including a leading one of the curved walls in the pair and a trailing one of the curved walls in the pair relative to the direction of rotation. Each leading one of the curved walls is connected with a selected leading one of the pulp lifter segments respectively, each leading one of the curved walls having a trailing edge surface. Each trailing one of the curved walls is connected with the trailing one of the pulp lifter segments in the pair thereof including the selected leading one of the pulp lifter segments. Each trailing one of the curved walls having a curved leading edge surface that is concave in relation to the direction of rotation and, with the leading edge surface of the selected leading one of the pulp lifter segments, forms a continuous leading wall that is partially straight and partially curved. The trailing edge surface of the leading one of the curved walls and the curved leading edge surface of the trailing one of the curved walls define an outer portion of each pulp chamber respectively, the outer portion of each pulp chamber being in fluid communication with the inner portion of each pulp chamber respectively. The leading wall is configured to accelerate the pulp through the pulp chamber partially thereby defined respectively to the central hole when the pulp chamber partially defined thereby is in the discharge condition thereof, for discharge of the pulp therefrom, to mitigate the extent to which the leading wall is subjected to wear by the pulp. The discharge wall system also includes a number of discharge grates for controlling flow of the pulp into the respective pulp chambers when the respective pulp chambers are in respective intake conditions thereof in which the pulp flows thereinto. The discharge grates partially define the pulp chambers.

### BRIEF DESCRIPTION OF THE DRAWINGS

The invention will be better understood with reference to the attached drawings, in which:

FIG. 1A (also described previously) is a schematic illustration showing certain selected solid particles in selected pulp chambers in a discharge wall assembly of the prior art moving in a clockwise rotation direction, the particles being located in pulp chambers positioned between the nine o'clock and three o'clock positions thereof;

FIG. 1B (also described previously) is a portion of the discharge wall assembly of FIG. 1A, drawn at a larger scale;

FIG. 1C (also described previously) is a schematic illustration of the pulp chambers of FIG. 1A and the selected solid particles therein further in the rotation direction, drawn at a smaller scale;

FIG. 1D (also described previously) is a schematic illustration of the pulp chambers of FIGS. 1A and 1B and the selected solid particles therein further in the rotation direction;

FIG. 1E (also described previously) is a longitudinal cross-section of a conventional grinding mill including the discharge wall assembly of FIGS. 1A-1D, drawn at a smaller scale;

FIG. 2A is an elevation view of an embodiment of a discharge end wall system of the invention (excluding certain discharge grates thereof), drawn at a larger scale;

FIG. 2B is a cross-section of the discharge wall system of FIG. 2A, drawn at a larger scale;

FIG. 2C is a longitudinal cross-section of an embodiment of a grinding mill of the invention, drawn at a smaller scale;

FIG. 2D is an elevation view of the discharge end wall system of FIGS. 2A-2C (including discharge grates), drawn at a smaller scale;

FIG. 2E is an elevation view of the discharge end wall system of FIG. 2D, in which a discharge grate is omitted;

FIG. 3A is an elevation view of a portion of the discharge end wall system of FIG. 2A, drawn at a larger scale;

FIG. 3B is a cross-section of the discharge end wall system of FIG. 3A, drawn at a larger scale;

FIG. 3C is a cross-section taken along line A-A in FIG. 3A, drawn at a larger scale; and

FIG. 3D is an elevation view of a portion of the discharge end wall system of FIG. 3A with two discharge grates included, drawn at a smaller scale.

### DETAILED DESCRIPTION

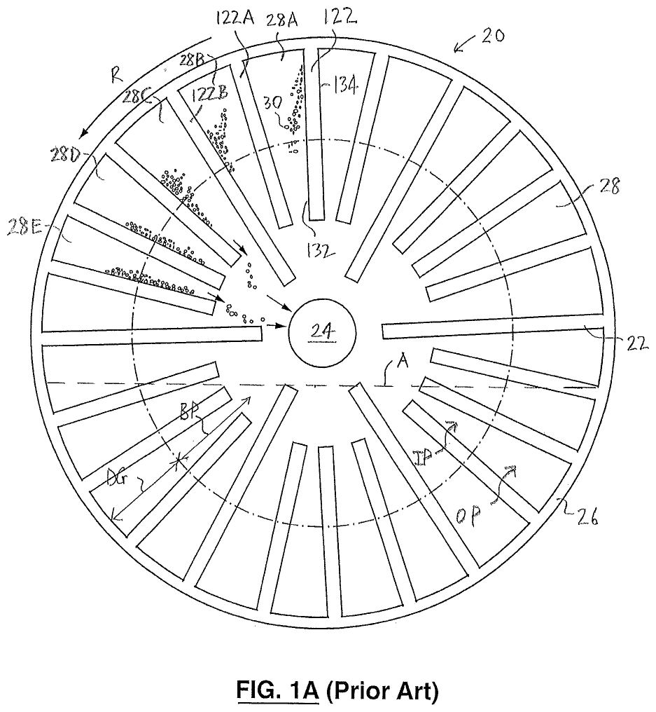

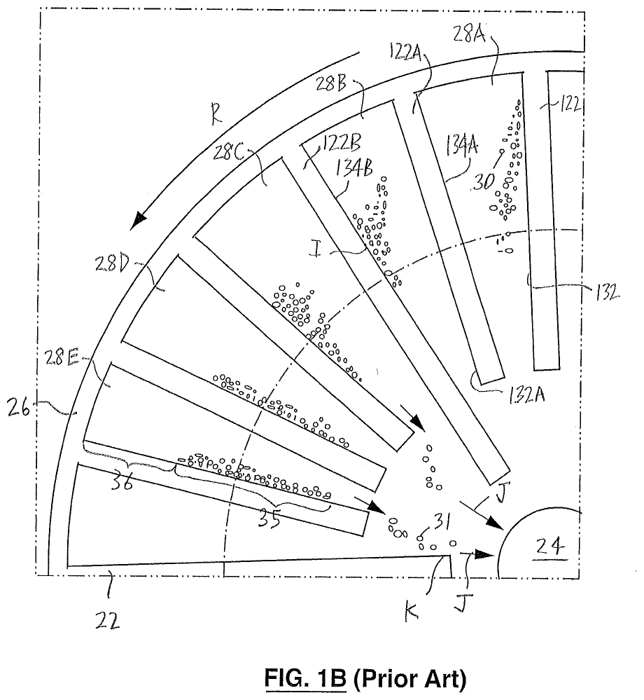

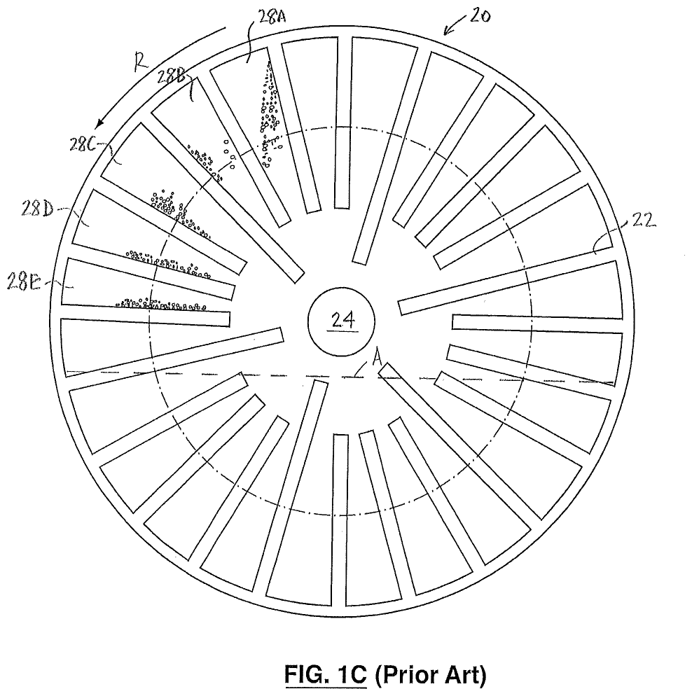

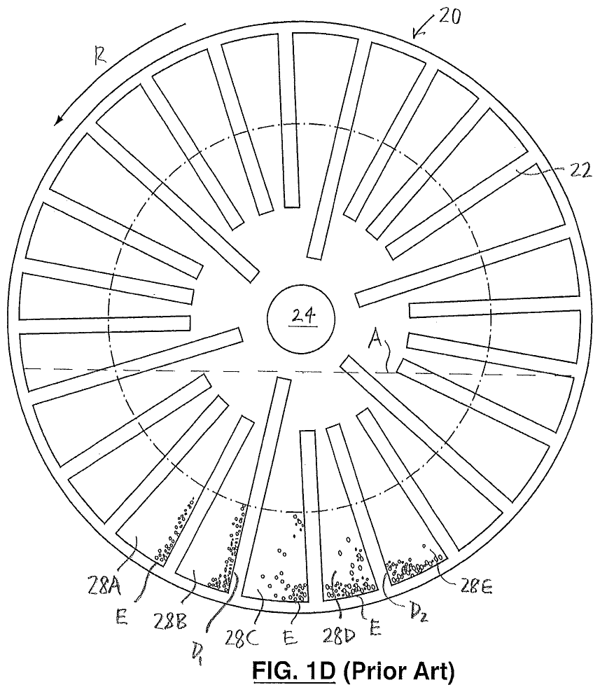

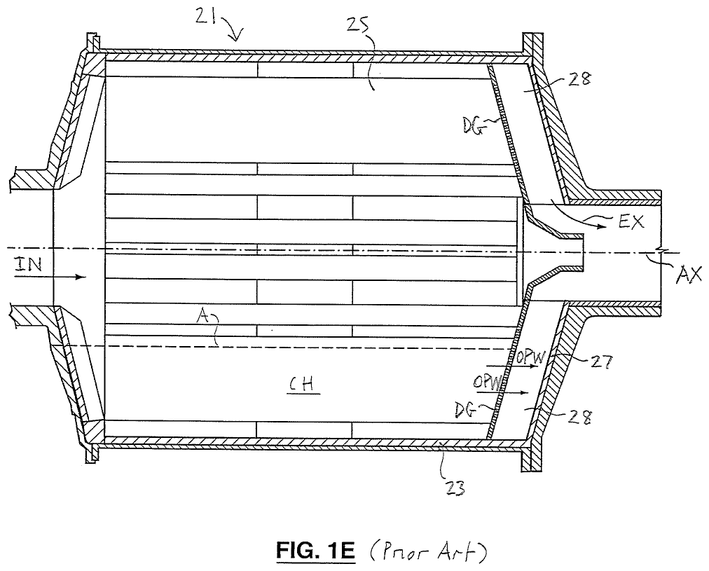

In the attached drawings, like reference numerals designate corresponding elements throughout. In particular, to simplify the description, the reference numerals previously used in FIGS. 1A-1E are used again in connection with the description of the invention hereinafter, except that each such reference numeral is raised by 100 (or by whole number multiples thereof, as the case may be), where the elements described correspond to elements referred to above.

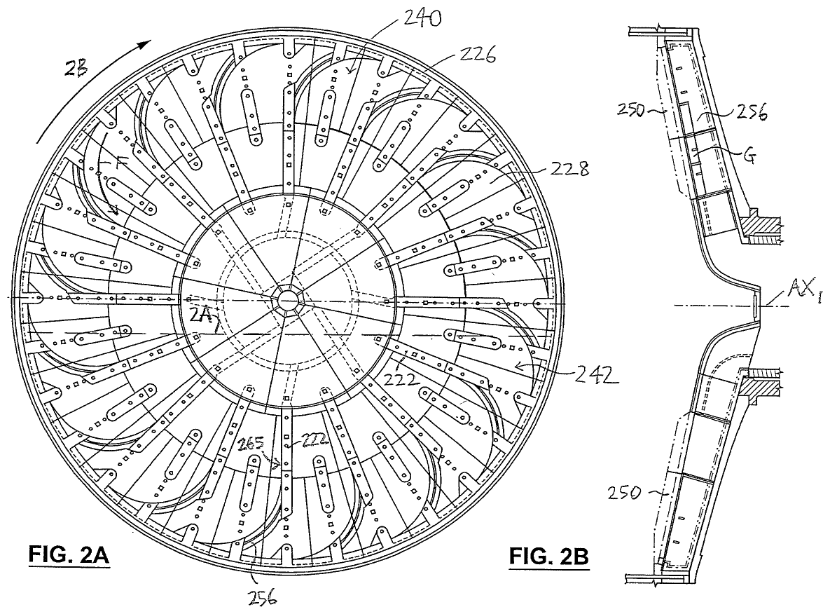

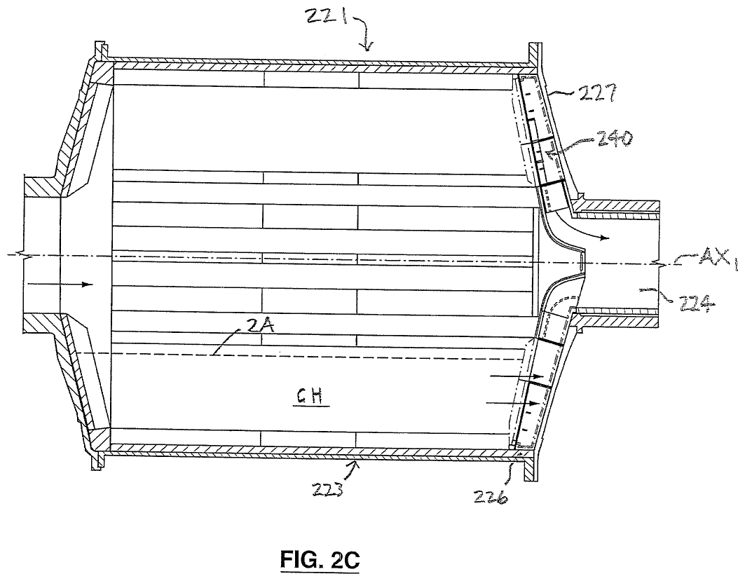

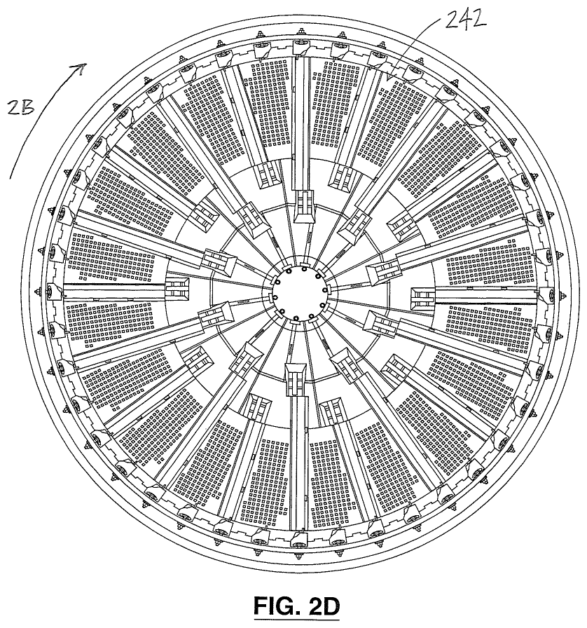

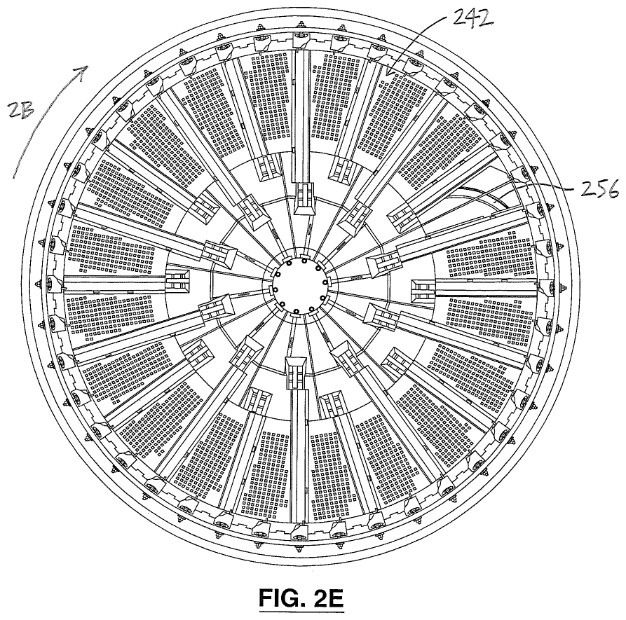

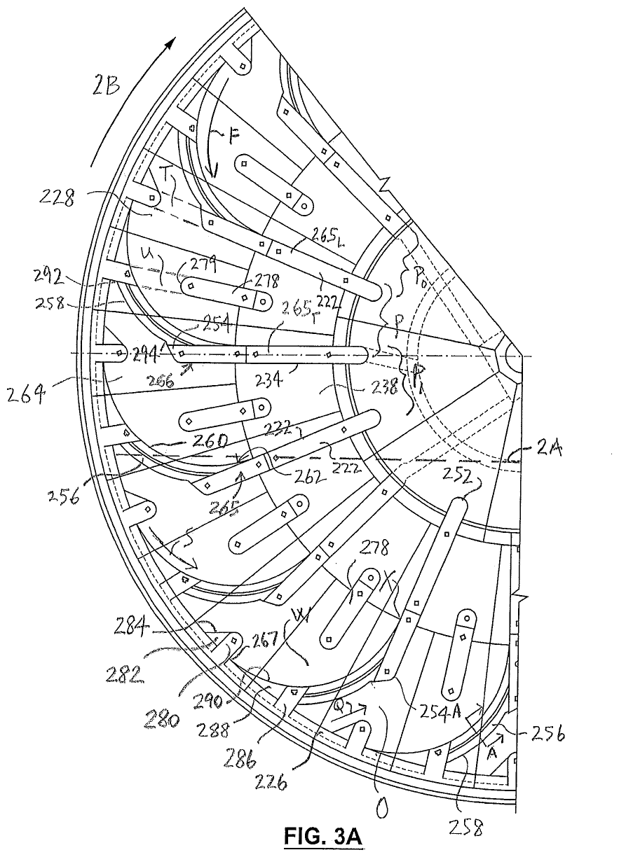

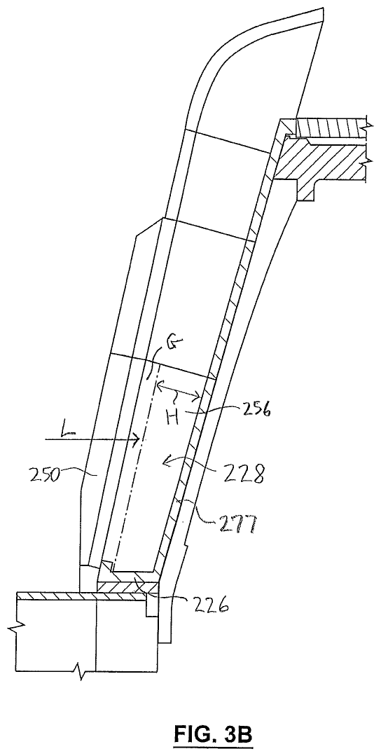

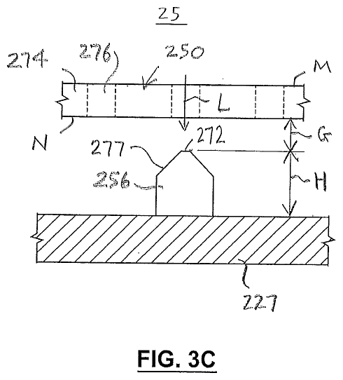

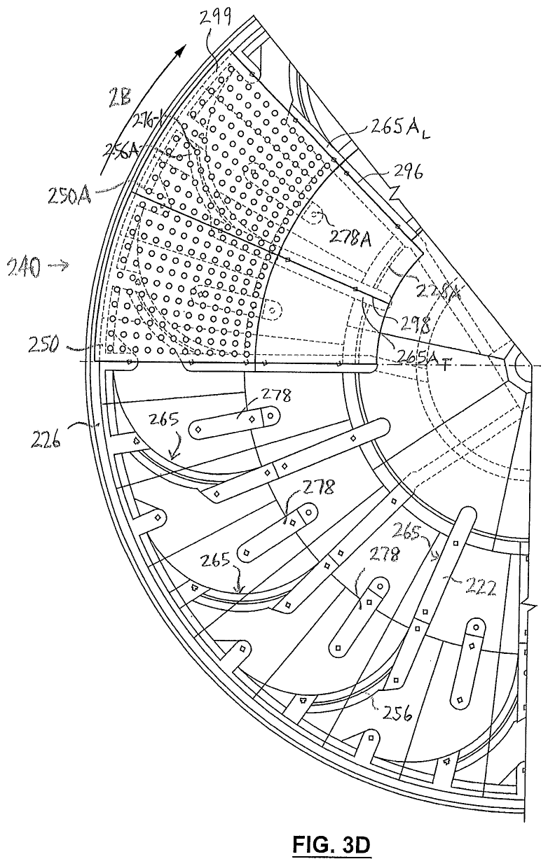

Reference is made to FIGS. 2A-3D to describe an embodiment of a discharge end wall system 240 mounted on a discharge end wall 227 of a mill shell 223 in a grinding mill 221 (FIG. 2C). The mill shell 223 is rotatable about an axis of rotation thereof “AX₁” (FIG. 2C) in a direction of rotation to produce the pulp, which includes ore particles and water (not shown). The discharge end wall 227 is partially defined by an outer perimeter wall 226 of the mill shell 223 and includes a central hole 224 through which the pulp exits the mill shell 223 (FIG. 2C). In one embodiment, and as can be seen in FIG. 2A, the discharge wall system 240 preferably includes a discharge end assembly 242 that includes a number of pulp lifter segments 222 radially arranged on the discharge end wall 227 relative to the axis of rotation “AX₁”. As will be described, the pulp lifter segments 222 preferably are arranged in pairs of adjacent ones thereof, and each pair respectively includes a leading one of the pulp lifter segments 222 in the pair and a trailing one of the pulp lifter segments 222 in the pair, relative to the direction of rotation. It is also preferred that a trailing edge surface 234 of the leading one of the pulp lifter segments and a leading edge surface 232 of the trailing one of the pulp lifter segments partially define inner portions 238 of respective pulp chambers 228 therebetween through which the pulp is at least partially directed to the central hole 224, when the pulp chambers 228 are in discharge conditions thereof respectively, in which the pulp exits therefrom. As will also be described, the discharge end wall system 240 preferably includes a number of discharge grates 250 (FIGS. 2B, 3D) for controlling flow of the pulp into the respective pulp chambers 228 when the respective pulp chambers 228 are in respective intake conditions thereof in which the pulp flows thereinto, the discharge grates 250 partially defining the pulp chambers 228. It will be understood that the discharge grates 250 are omitted from FIGS. 2A and 3A for clarity of illustration.

As can be seen in FIG. 3A, each of the pulp lifter segments 222 extends between an inner end 252 thereof located proximal to the central hole 224, and an outer end 254 thereof spaced apart from the outer perimeter wall 226. Preferably, the discharge end wall system 240 also includes a number of curved walls 256 arranged in pairs of adjacent ones thereof (FIG. 3A). Each pair respectively includes a leading one of the curved walls in the pair and a trailing one of the curved walls relative to the direction of rotation. It is also preferred that each leading one of the curved walls 256 is connected with a selected leading one of the pulp lifter segments 222 respectively. Also, each leading one of the curved walls 256 preferably includes a trailing edge surface 258 (FIG. 3A). Each trailing one of the curved walls 256 preferably is connected with the trailing one of the pulp lifter segments 222 in the pair thereof that includes the selected leading one of the pulp lifter segments 222.

Each trailing one of the curved walls 256 preferably includes a curved leading edge surface 260 thereof that is concave in relation to the direction of rotation and, with the leading edge surface 232 of the selected leading one of the pulp lifter segments 222, forms a continuous leading wall 262 (FIG. 3A). As will also be described, as a result, the continuous leading wall 262 is both partially straight and partially curved. It is also preferred that the trailing edge surface 258 of the leading one of the curved walls 256 and the curved leading edge surface 260 of the trailing one of the curved walls 256 define an outer portion 264 of each respective pulp chamber 228. The outer portion 264 of each pulp chamber is in fluid communication with the inner portion 238 of each respective pulp chamber 228 respectively. Preferably, the continuous leading wall 262 is configured to accelerate the pulp through the pulp chamber 228 partially defined thereby respectively when the pulp chamber 228 is in the discharge condition thereof, for discharge of the pulp therefrom, to mitigate the extent to which the leading wall 262 is subjected to wear by the pulp.

The acceleration of the pulp toward the central hole 224 is due to the influence of gravity on the pulp. Those skilled in the art would appreciate that the pulp that is supported by the pulp lifter segment 222 of the wall 262 is subjected to acceleration due to gravity. However, as will be described, the pulp supported by the curved leading edge surface 260 of the continuous leading wall 262 is subjected to substantially more acceleration toward the central hole 224 than the pulp in the same pulp chamber that is supported by the pulp lifter segment 222 at that time.

The direction of rotation of the discharge wall 227 is indicated by arrow “2B” in FIGS. 2A and 3A. As can be seen in FIGS. 2A and 3A, the discharge end assembly 242 preferably includes a number of pulp lifter elements 265. Each of the pulp lifter elements 265 includes one of the pulp lifter segments 222, and one of the curved walls 256. As noted above, each of the curved walls 256 is connected to one of the pulp lifter segments 222 respectively. As can be seen in FIG. 3A, the pulp lifter elements 265 preferably are arranged in pairs, located equidistant from each other radially around the axis “AX₁”. One of the pulp lifter elements 265 in each of the pairs is the leading pulp lifter element, and the other pulp lifter element in the pair is the trailing pulp lifter element therein, for the pulp lifter chamber 228 that is defined therebetween. For example, in FIG. 3A, the leading pulp lifter element in respect of a particular pulp chamber is identified with reference character 265_{L} for convenience, and the trailing pulp lifter element in respect of the particular pulp chamber 228 is identified with reference character 265_{T} for convenience. For clarity of illustration, the pair that includes the leading and trailing pulp lifter elements 265_{L}, 265_{T} is identified in FIG. 3A by reference character “P”.

It will be understood that the adjacent pairs of pulp lifter elements share pulp lifter elements, and to that extent, may be said to overlap. For example, those skilled in the art would appreciate that the leading pulp lifter element 265_{L} is, in the pair preceding the pair “P” relative to the direction of rotation, the trailing pulp lifter. (The pair immediately preceding the pair “P” is identified in FIG. 3A for convenience as pair “P_{O}”.) Similarly, in the pair of pulp lifter elements immediately following the pair “P” relative to the direction of rotation, the trailing pulp lifter element 265_{T} is the leading pulp lifter element. (The pair immediately following the pair “P” is identified in FIG. 3A for convenience as pair “P₁”.)

As can be seen in FIG. 3D, in one embodiment, the discharge grates 250 that are preferably included in the system 240 preferably have linear respective first and second sides that are located radially relative to the axis of rotation. For example, in FIG. 3D, the discharge grate 250A has first and second linear (or straight) sides identified for convenience by reference characters 296, 298 respectively. It will be understood that one of the discharge grates is identified in FIG. 3D by reference character 250A for clarity of illustration.

It will also be understood that only two discharge grates are shown in FIG. 3D, and the other discharge grates are omitted from FIG. 3D, for clarity of illustration.

As can also be seen in FIG. 3D, the straight sides of the discharge grates 250 preferably are aligned with only the pulp lifter segments 222 of the leading and trailing pulp lifter elements 265. The curved walls 256 that are included in the leading and trailing pulp lifter elements 265 are not aligned with the straight sides of the discharge grates. Because of the generally conventional configuration of the discharge grates 250, they can be secured to the pulp lifter segments 222 of the pulp lifter elements 265, because the pulp lifter segments 222 are substantially straight, and radially located relative to the axis of rotation.

For example, in FIG. 3D, a pulp chamber 228A is identified that is partially defined by the discharge grate 250A. The pulp chamber 228A is also partially defined by the leading and trailing pulp lifters 265A_{L}, 265A_{T}. As can be seen in FIG. 3D, the discharge grate 250A includes an outer edge 299 that is supported by a portion of the outer perimeter wall 226. The discharge plate 250A is also supported by the intermediate support element 278A, which is located in the pulp chamber 228A. It will be understood that the discharge plate 250A is secured to (i) the respective pulp lifter segments 222 of the leading and trailing pulp lifter elements 265A_{L}, 265A_{T}; (ii) the outer perimeter wall 226; and (iii) the intermediate support element 278A. The discharge grate 250A preferably is secured to the respective pulp lifter segments 222, the outer perimeter wall 226, and the intermediate support element 278A by any suitable fasteners (not shown). Those skilled in the art would appreciate that the discharge grates are conventional, or largely conventional, although the pulp lifter elements 265 and the intermediate support elements 278 are not conventional. However, the pulp lifter elements 265 are novel, and the system 240, which includes the discharge grates 250 secured to the pulp lifter segments 222 of the pulp lifter elements 265, is also novel. Those skilled in the art would appreciate the advantages of the arrangement illustrated in FIG. 3D. Because the discharge grates 250 preferably are of conventional construction, they are less expensive to manufacture than discharge grates. Also, although the manner in which the discharge grates are secured in place is only partly conventional, it is sufficiently straightforward that the process of installing and replacing the discharge grates 250 may be done relatively quickly, and are relatively inexpensive.

From the foregoing, it can be seen that the advantages resulting from the pulp lifters with curved walls 256 are combined, in the discharge end wall system 240 of the invention, with the advantages of utilizing conventional discharge grates 250, i.e., discharge grates with linear (straight) sides thereof that are located radially relative to the axis of rotation, once installed in the mounted discharge end wall system.

It is also preferred that, in a selected pair, the trailing edge surface 234 of the leading one of the pulp lifter segments 222 and the trailing edge surface 258 of the leading one of the curved walls 256 (i.e., the trailing edge surface 234 and the trailing edge surface 258 of the leading pulp lifter element 265_{L}) form a continuous trailing wall 266 of the pulp lifter element 265 thereof. It will also be understood that each of the pulp lifter elements 265 includes the continuous leading wall 262.

As can be seen in FIG. 3A, the continuous leading wall 262 of the trailing pulp lifter element 265_{L} in the selected pair “P” is both curved in part, and straight, in part. As can also be seen in FIG. 3A, each of the pulp chambers 228 preferably is partially defined by the continuous leading wall 262 and the continuous trailing wall 266 of the respective trailing and the leading pulp lifter elements 265 thereof. As noted above, each of the pulp chambers 228 preferably is also partially defined by one or more of the discharge grates 250 (FIG. 3B).

It is also preferred that the continuous leading wall 262 extends between an outer end 268 of the curved wall 296 thereof that is connected with the outer perimeter wall 226 of the mill shell 223, and the inner end 252 of the pulp lifter segment 222 thereof.

As can be seen in FIGS. 2A and 3A, the transition between the curved leading edge surface 260 of the curved wall 256 and the leading edge surface 232 of the pulp lifter segment 222 preferably is gradual, i.e., the leading edge surface 232 preferably is tangential to the curved leading edge surface 260 at a point “X” where they meet. It is preferred that the transition from the curved surface 260 to the leading edge surface 232 is smooth and continuous so that the particles moving toward the central hole from the curved leading edge surface 260 may be accelerated, without encountering any obstacles or impediments to their movement at the transition point “X”.

It is also preferred that the outer perimeter wall 226 is tangential to an outer end 267 of the curved wall 256, where the outer end 267 meets the outer perimeter wall. The continuous leading wall 262 is formed so that it offers no obstacles to impede the movement of the pulp along it toward the central hole 224, while the pulp chamber partially defined by the continuous leading wall is in the first half of the discharge condition.

As can be seen in FIGS. 2A and 2C, in use, the charge “CH” is positioned in the mill shell 223 as the mill shell 223 rotates. The top surface of the charge is identified by reference character “2A” in FIG. 2A. Those skilled in the art would appreciate that the position of the top surface “2A” of the charge “CH” may vary considerably. It will be understood that the charge “CH” as illustrated is exemplary only.

As illustrated in FIGS. 2A, 2C, and 3A, the mill shell 223 rotates about its axis of rotation “AX₁” in the clockwise direction indicated by arrow “2B” in FIGS. 2A and 3A. It can be seen in FIGS. 2A and 3A that the concavities defined by the curved walls respectively are generally open toward the direction of rotation.

As noted above, the grinding mill may, alternatively, be constructed so that the mill shell 223 rotates in a counter-clockwise direction. As will be described, if the mill shell rotated in the counter-clockwise direction, then the curved walls 256 would be positioned differently, i.e., so that the concavities thereof are generally facing in the direction of rotation.

Those skilled in the art would appreciate that, as the mill shell 223 rotates about the axis of rotation “AX₁”, the pulp lifter elements 265 and the pulp chambers 228 defined therebetween are rotated also. Those skilled in the art would also appreciate that, as the mill shell 223 rotates about its axis of rotation “AX₁”, the discharge grate on each respective pulp chamber 228 is alternatively immersed in the charge “CH”, and raised above the charge “CH”. As noted above, such rotation preferably is at a relatively high speed, e.g., the discharge wall 227 may complete one rotation every six seconds (10 rpm). The mill shell 223 may be relatively large, for example, approximately 40 feet in diameter, or larger.

When the discharge grate 250 is immersed in the charge, the pulp in the charge flows into the pulp chamber partially defined thereby under the influence of gravity, to the extent that at least a part of the pulp chamber 228 that is located below the top surface “2A” of the charge “CH” is unoccupied. For the purposes hereof, the pulp chamber 228 that is at least partially unoccupied is said to be in an “intake condition” while it is at least partially immersed in the charge, and the pulp is able to flow into that pulp chamber. Similarly, while a pulp chamber 228 is at least partially located above the top surface “2A” of the charge, and therefore located so that the pulp therein may exit therefrom, the pulp chamber is said to be in a “discharge condition”. Those skilled in the art would appreciate that the pulp exiting the pulp chamber flows to the central hole 224 and then exits the mill shell 223.

Those skilled in the art would also appreciate that in each rotation, each of the pulp chambers may be very briefly positioned between the intake and discharge conditions, so that at that point, the charge flows neither into, nor out of, the pulp chamber 228. The pulp chamber is between the intake and the discharge conditions when it is approximately at the three o'clock position and approximately at the nine o'clock position, depending on the amount of the charge in the grinding mill.

Referring to FIG. 2A, those skilled in the art would appreciate that the pulp in a pulp chamber that is located in a first half of the discharge condition (e.g., any of the pulp chambers located approximately between the nine o'clock and the twelve o'clock positions in FIG. 2A) will initially be supported by the continuous leading wall 262 of the trailing pulp lifter element 265 of each pulp chamber respectively. As the trailing pulp lifter element in any pulp chamber is raised due to rotation of the mill shell, e.g., from the pulp lifter segment 222 thereof being located at approximately the nine o'clock position to being located at approximately the ten o'clock position, the portion of the pulp that is supported by the curved wall 256 of the trailing pulp lifter element is accelerated toward the central hole 224, due to the concavity of the curved leading edge surface. When the pulp chamber is in the first part of the discharge condition, such acceleration is greater than the acceleration of the pulp located on the pulp lifter segment 222 of the same pulp lifter element 265, because the curved leading edge surface 2160 forms a surface that is more steeply oriented (relative to the vertical) than the leading edge 232 of the pulp lifter segment 222. This acceleration is increased due to the ever more vertical positioning of the curved wall 256 as the mill shell rotates, until the pulp lifter segment 222 of the trailing pulp lifter element 265 is approximately at the twelve o'clock position, after which point the curved wall 256 does not support the pulp, i.e., while the pulp chamber is positioned above the charge. For the purposes hereof, a pulp chamber is considered to be in the second half of the discharge condition as the pulp lifter segment 222 of the trailing pulp lifter element 265 of the pulp chamber is moved from approximately the twelve o'clock position thereof to approximately the three o'clock position thereof, as the mill shell is rotated clockwise.

While the pulp chamber 228 moves through the first half of the discharge condition, a portion of the pulp supported by the trailing pulp lifter element 265 is supported by the curved wall thereof, and another portion is supported by the pulp lifter segment 222. The acceleration of the pulp that is supported by the curved wall is greater than the acceleration at the same time to which the portion of the pulp that is supported by the pulp lifter segment is subjected.

It is believed that, when the pulp lifter segment 222 of the pulp lifter element is approximately between the nine o'clock and the twelve o'clock positions, due to the influence of gravity and the curvature of the curved wall portion 256, the pulp located on the curved wall 256 is accelerated in the direction indicated by arrow “F” in FIG. 2A. It is also believed that, due to such acceleration, the pulp is discharged more quickly from the pulp chambers, so that there is also much less carryover than in the discharge wall assembly of the prior art.

Testing done to date indicates that the discharge wall system of the invention generally holds less carryover pulp than the conventional discharge wall system illustrated in FIGS. 1A-1E.

Those skilled in the art would appreciate that, if the mill shell were to be rotated in the counter-clockwise direction, the curved walls would be positioned differently, i.e., in order to position the concavities defined thereby so that they are generally facing in the counter-clockwise direction. It will be understood that only the discharge wall assembly of the invention configured for a mill shell arranged for rotation in the clockwise direction is illustrated for clarity of illustration.

It will also be understood that, where the mill shell is rotated counter-clockwise, the pulp chamber that is between approximately the three o'clock position and approximately the twelve o'clock position is in the first half of the discharge condition thereof. For the purposes hereof, where the mill shell rotates counter-clockwise, the pulp chamber that is between approximately the twelve o'clock position and the nine o'clock position is considered to be in the second half of the discharge condition thereof.

As can be seen in FIGS. 2A-3B, each curved wall preferably is mounted to the discharge end wall 227. The curved wall 256 preferably extends between a base portion 270 thereof secured to the discharge end wall 227 and an exposed edge 272 positioned a predetermined distance “H” from the discharge end wall 227. As can be seen in FIG. 3C, the exposed edge 272 preferably is positioned to define a gap “G” between the exposed edge 272 and one or more of the discharge grates 250 that at least partially define the pulp chamber 228 that is also partially defined by the curved wall 256.

As can be seen, e.g., in FIG. 3C, the discharge grate 250 includes a body portion 274 with apertures 276 therein to permit the pulp to flow therethrough into the respective pulp chambers, when the pulp chambers are in the intake conditions thereof respectively. It is preferred that each of the curved walls 256 is configured to permit the pulp to flow through the apertures 276 of the discharge grate 250 that at least partially defines the pulp chamber 228 that is also partially defined by the curved wall 256. The movement of the pulp through one of the apertures 276 and into the gap “G” is represented by arrow “L” in FIG. 3C.

In one embodiment, the curved wall 256 preferably includes chamfered surfaces 277 that are adjacent to the top edge 272 of the curved wall (FIG. 3C). Those skilled in the art would appreciate that the chamfered surfaces 277 tend to direct pulp entering through the apertures 276 into the pulp chambers on opposite sides of the curved wall.

For example, those skilled in the art would appreciate that, when the pulp chamber 228 is at least partially immersed in the charge “CH”, the pulp may flow through the apertures 276 and into the pulp chamber 228 via the gap “G”, as indicated by arrows “L” in FIG. 3C. In FIG. 3D, a curved wall 256A is illustrated in dashed lines. Those skilled in the art would appreciate that, as illustrated in FIG. 3D, the discharge grate 250A is directly observable, and the curved wall 256A is located behind the discharge grate 250A, from the observer's point of view.

As can be seen in FIG. 3D, because the discharge grates are conventional (i.e., with substantially straight sides), the curved wall 256A is aligned with certain of the apertures in the discharge grate 250A. For convenience, one of such apertures is identified by reference character 276-1 in FIG. 3D. However, as can be seen in FIG. 3C, the curved wall 256 preferably is constructed and positioned to define the gap “G” between the discharge grate 250 and the curved wall 256, so that the curved wall does not block any of the apertures 276 in the discharge grate 250. Because of the gap “G” between the exposed edge 272 of the curved wall 256 (FIG. 3C), the curved wall 256 does not block any of the apertures 276.

As can be seen in FIG. 3C, the discharge grate 250 has an outer side “M” that faces the mill shell chamber 25. The discharge grate 250 also has an inner side “N”, opposite to the outer side “M”, that partially defines the pulp chamber over which the discharge grate 250 is located. The inner side “N” faces the exposed edge 272 of the curved wall 256.

Those skilled in the art would appreciate that, in plan view, the discharge grates 250 preferably are formed to cover (and partially define) the pulp chambers, in a 360° radius around the axis “AH₁”. As is well known in the art, the discharge grates 250 preferably are formed to be secured to at least the pulp lifter segments 222 respectively. The discharge grates 250 may also be formed to be secured to the perimeter wall 226. From the foregoing, it can be seen that because of the configuration of the curved wall 256, i.e., defining the gap “G” between the curved wall 256 and the discharge grate 250, the curved wall 256 does not block any of the apertures 276 of the discharge grate 250.

In one embodiment, the discharge end wall system 240 preferably includes a number of the intermediate support elements 278 (FIG. 3D). Preferably, one or more of the support elements 278 is located in each said pulp chamber 228 respectively to support the respective discharge grate 250 that at least partially defines the respective pulp chamber 228. As will be described, in a mill in which the discharge wall assembly 242 of the invention is retrofitted into a prior art grinding mill, the intermediate support elements 278 may be formed out of pulp lifters.

As can be seen in FIG. 2C, the invention preferably includes the grinding mill 221. The grinding mill 221 preferably includes the discharge end wall system 240, mounted on the discharge end wall 227 thereof.

In use, as the mill shell rotates about its axis “AX₁”, causing the pulp chambers 228 that are respectively partially defined by the leading and trailing pulp lifter elements 265 to rotate, the pulp chambers 228 are sequentially moved into the intake conditions thereof, and subsequently moved into the discharge conditions thereof, before they are immersed again, one after the other, respectively. As described above, the pulp that is in any one of the pulp chambers 228, when it is positioned in the first half of the intake condition, that is supported by the curved wall of the trailing pulp lifter element thereof and approximately between the nine o'clock and the twelve o'clock positions (i.e., assuming clockwise rotation) is accelerated toward the central hole 224, due to the influence of gravity.

Such acceleration is greater than any acceleration at that time of the pulp in the same pulp chamber 228 that is supported by the pulp lifter segments 222, under the influence of gravity. Due to the acceleration of the pulp supported by the curved wall, the amount of carryover is reduced.

The system 240 of the invention may be configured in an existing grinding mill, e.g., a grinding mill of the prior art including a discharge wall assembly such as that illustrated in FIGS. 1A-1E. Although conventional discharge wall assemblies may be provided in various configurations, straight pulp lifters positioned radially are relatively common.

In order to retrofit the system 240 of the invention into a conventional grinding mill in which the pulp lifters are radially straight, relative to the central axis, the discharge grates 250 preferably are removed. Next, the outer portions of each of the straight pulp lifters are removed, to allow the pulp lifter segments 222 to remain on the discharge wall 227. As examples, removed outer portions are illustrated in dashed lines and identified by reference characters “T” and “U” in FIG. 3A. It will be understood that the outer portions preferably are removed from all of the straight pulp lifters in the pre-existing discharge wall assembly. It can be seen in FIG. 3A that the pulp lifter segment 222 is formed by the removal of the outer portion “T” from a longer straight pulp lifter, and the intermediate support element 278 is formed by the removal of the outer portion “U” from a shorter straight pulp lifter. For each pulp lifter segment 222, the removal of the outer portion “T” thereof defines an open space “O” outwardly from the outer end 254 of the pulp lifter segment 222 (FIG. 3A). Also, for each intermediate support element 278, the removal of the outer portion “U” thereof defines an open space “W” outwardly from an outer end 279 of the intermediate support element 278 (FIG. 3A). The respective curved walls 256 are then mounted on the discharge wall 227, extending generally outwardly from the outer end 254 toward the outer perimeter wall 226.

It will be understood that, in the example illustrated in FIGS. 2A, 3A, and 3D, the pre-existing discharge wall assembly included alternating long and short straight pulp lifters. Those skilled in the art would appreciate that the pre-existing discharge wall assembly may include any arrangement of substantially straight (i.e., radially positioned) pulp lifters.

As can be seen in FIG. 3A, in one embodiment, an outer pulp lifter segment 280 preferably also remains in position, radially aligned with the pulp lifter segment 222. To minimize the impact of the outer pulp lifter segment 280 on the flow of the pulp through the pulp chambers, it is preferred that the discharge end wall assembly 242 includes fillets 282 positioned beside the outer pulp lifter segments 280, facing in the direction of rotation. It is preferred that the fillet 282 engages the outer perimeter wall 226 and an upstream side of the outer pulp lifter segment 280. Preferably, each of the fillets 282 includes a fillet face 284 that is facing toward the direction of rotation. The fillet face 284 preferably directs the pulp engaged with it through the pulp chamber 228 in which the fillet 282 is located. The direction of the pulp that is redirected by the fillet 282 is indicated by arrow “Q” in FIG. 3A.

Those skilled in the art would appreciate that the pulp lifter segment 222 and the outer pulp lifter segment 280 may be formed from the conventional straight pulp lifter. To do so, a portion (not shown) of the conventional straight, and relatively long, pulp lifter is removed, to provide the open area “O”, and to leave the pulp lifter segment 222 and the outer pulp lifter segment 280.

As can also be seen in FIG. 3A, the discharge wall assembly 242 preferably also includes outer support elements 286 that are substantially radially aligned with the respective intermediate support elements 278. It will be appreciated by those skilled in the art that the outer support elements 286 preferably are also used to support discharge grates 250, which may be secured to the outer support elements 286.

Those skilled in the art would also appreciate that the intermediate support element 278 and the outer support element 286 preferably are formed from a relatively short straight radial pulp lifter in a prior art discharge wall assembly to define a space “R” therebetween, which is included in the pulp chamber 228 in which the intermediate support element 278 is located. From the foregoing, it can be seen that the discharge wall system 240 of the invention may be configured by modification of a discharge wall assembly of the prior art. Preferably, the discharge wall assembly 242 is formed, first, by removal of portions of the radial pulp lifters to define the pulp lifter segment 222 and the outer pulp lifter segment 280. Also, portions of the other (shorter, as illustrated) pulp lifters forms the respective intermediate support elements 278 and the outer support elements 286 radially aligned therewith respectively. The curved walls 256 preferably are connected to the outer ends of the pulp lifter segments 222.

Preferably, the discharge wall assembly 242 also includes support element fillets 288 having faces 290 thereof formed to face generally in the direction of rotation. As can also be seen in FIG. 3A, in one embodiment, the face 290 preferably is curved to complement the curved leading edge surface 260 proximal thereto. The arc defining the face 290 preferably is the same as the arc of the adjacent curved leading edge surface 260. As a result, the face 290 preferably directs the pulp entering into the pulp chamber 228 along the curved leading surface 260, as indicated by arrow “S” in FIG. 3A.

In contrast to the generally smooth profile of the continuous leading wall 262, the continuous trailing wall 266 may have any suitable profile. As can be seen in FIG. 3A, in one embodiment, the trailing edge surface 258 preferably extends between an outer end 292 thereof, which is secured to a selected one of the outer support elements 286, and an inner end 294 thereof, which is secured to the outer end 254 of the pulp lifter segment 222 to which the curved wall 256 thereof is secured. The selected one of the outer support elements 286 is the outer support element 286 that is positioned immediately prior to the pulp lifter segment 222, relative to the direction of rotation. Those skilled in the art would appreciate that the continuous trailing wall 266 may have any suitable shape or profile. As can be seen in FIGS. 2A and 3A, the pulp in the pulp chamber defined by any particular continuous trailing wall 266 is not likely to be supported by the continuous trailing wall 266. However, in order that the continuous trailing wall 266 not offer any impediment to the flow of the pulp through the pulp chamber partially defined thereby, the trailing edge surface 258 preferably is generally parallel to the curved leading edge surface 260 that also partially defines the pulp chamber.

It will be appreciated by those skilled in the art that the invention can take many forms, and that such forms are within the scope of the invention as claimed. The scope of the claims should not be limited by the preferred embodiments set forth in the examples, but should be given the broadest interpretation consistent with the description as a whole.

We claim:

1. A discharge end wall system mounted on a discharge end wall of a mill shell in a grinding mill, the mill shell being rotatable about an axis of rotation thereof in a direction of rotation to produce a pulp including ore particles and water, the discharge end wall being partially defined by an outer perimeter wall of the mill shell and comprising a central hole through which the pulp exits the mill shell, the discharge wall system comprising:
a discharge end assembly comprising:
a plurality of pulp lifter segments radially arranged on the discharge end wall relative to the axis of rotation;
said pulp lifter segments being arranged in pairs of adjacent ones thereof, each said pair respectively comprising a leading one of the pulp lifter segments in the pair and a trailing one of the pulp lifter segments in the pair relative to the direction of rotation, a trailing edge surface of the leading one of the pulp lifter segments and a leading edge surface of the trailing one of the pulp lifter segments partially defining inner portions of respective pulp chambers therebetween through which the pulp is at least partially directed to the central hole, when the pulp chambers are in discharge conditions thereof respectively, in which the pulp exits therefrom;
each said pulp lifter segment extending between an inner end thereof located proximal to the central hole, and an outer end thereof spaced apart from the outer perimeter wall;
a plurality of curved walls arranged in pairs of adjacent ones thereof, each said pair respectively comprising a leading one of the curved walls in the pair and a trailing one of the curved walls in the pair relative to the direction of rotation;
each said leading one of the curved walls being connected with a selected leading one of the pulp lifter segments respectively, each said leading one of the curved walls comprising a trailing edge surface;
each said trailing one of the curved walls being connected with the trailing one of the pulp lifter segments in the pair thereof comprising the selected leading one of the pulp lifter segments, each said trailing one of the curved walls comprising a curved leading edge surface that is concave in relation to the direction of rotation and, with the leading edge surface of the selected leading one of the pulp lifter segments, forms a continuous leading wall that is partially straight and partially curved;
the trailing edge surface of the leading one of the curved walls and the curved leading edge surface of the trailing one of the curved walls defining an outer portion of each said pulp chamber respectively, the outer portion of each said pulp chamber being in fluid communication with the inner portion of each said pulp chamber respectively;
the leading wall being configured to accelerate the pulp through the pulp chamber partially thereby defined respectively to the central hole when the pulp chamber partially defined thereby is in the discharge condition thereof, for discharge of the pulp therefrom, to mitigate the extent to which the leading wall is subjected to wear by the pulp; and
a plurality of discharge grates for controlling flow of the pulp into the respective pulp chambers when the respective pulp chambers are in respective intake conditions thereof in which the pulp flows thereinto, said discharge grates partially defining the pulp chambers.

2. The discharge end wall system according to claim 1 in which each said discharge grate is partially defined by respective linear first and second sides thereof that are located radially relative to the axis of rotation.

3. The discharge end wall system according to claim 1 in which each said leading wall extends between an outer end of the curved wall thereof that is connected with the outer perimeter wall of the mill shell, and the inner end of the pulp lifter segment thereof.

4. The discharge end wall system according to claim 1 in which each said curved wall is mounted to the discharge end wall and extends between a base portion thereof secured to the discharge end wall and an exposed edge positioned a predetermined distance from the discharge end wall, the inner edge being positioned to define a gap between the inner edge and at least one of the discharge grates that at least partially defines the pulp chambers that are also partially defined by said curved wall.

5. The discharge wall system according to claim 1 in which:
each said discharge grate comprises a body portion with apertures therein to permit the pulp to flow therethrough into the respective pulp chambers, when the pulp chambers are in the intake conditions thereof respectively; and
each said curved wall is configured to permit the pulp to flow through the apertures of at least one of the discharge grates that at least partially defines the pulp chambers that are also partially defined by said curved wall.

6. The discharge end wall system according to claim 1 additionally comprising a plurality of intermediate support elements, at least one of the support elements being located in each said pulp chamber respectively to support the respective discharge grate that at least partially defines said respective pulp chamber.

7. A grinding mill comprising:
a mill shell comprising a mill shell chamber therein and having an outer perimeter wall partially defining a discharge end wall of the mill shell, rotatable in a direction of rotation to produce a pulp including ore particles and water;
the discharge end wall having a central hole therein through which the pulp exits the mill shell;
a discharge end assembly comprising:
a plurality of pulp lifter segments radially arranged on the discharge end wall relative to the axis of rotation;
said pulp lifter segments being arranged in pairs of adjacent ones of the pulp lifter segments, each said pair respectively comprising a leading one of the pulp lifter segments in the pair and a trailing one of the pulp lifter segments in the pair relative to the direction of rotation, a trailing edge surface of the leading one of the pulp lifter segments and a leading edge surface of the trailing one of the pulp lifter segments partially defining inner portions of respective pulp chambers therebetween through which the pulp is at least partially directed to the central hole when the respective pulp chambers are in discharge conditions thereof respectively, in which the pulp exits therefrom;
each said pulp lifter segment extending between an inner end thereof located proximal to the central hole, and an outer end thereof spaced apart from the outer perimeter wall;
a plurality of curved walls arranged in pairs of adjacent ones thereof, each said pair respectively comprising a leading one of the curved walls in the pair and a trailing one of the curved walls relative to the direction of rotation;
each said leading one of the curved walls being connected with a selected leading one of the pulp lifter segments respectively, each said leading one of the curved walls comprising a trailing edge surface;
each said trailing one of the curved walls being connected with the trailing one of the pulp lifter segments in the pair thereof comprising the selected leading one of the pulp lifter segments, each said trailing one of the curved walls comprising a curved leading edge surface that is concave in relation to the direction of rotation and, with the leading edge surface of the selected leading one of the pulp lifter segments, forms a continuous leading wall that is partially straight and partially curved;
the trailing edge surface of the leading one of the curved walls and the curved trailing edge surface of the trailing one of the curved walls define an outer portion of each said pulp chamber respectively, the outer portion of each said pulp chamber being in fluid communication with the inner portion of each said pulp chamber respectively;
the leading wall being configured to accelerate the pulp through the pulp chamber partially defined thereby respectively when the pulp chamber partially defined thereby is in the discharge condition thereof, for discharge of the pulp therefrom, to mitigate the extent to which the leading wall is subjected to wear by the pulp; and
a plurality of discharge grates for controlling flow of the pulp into the respective pulp chambers when the respective pulp chambers are in respective intake conditions thereof in which the pulp flows thereinto, said discharge grates partially defining the pulp chambers;

8. The grinding mill according to claim 7 in which each said discharge grate is partially defined by respective linear first and second sides thereof that are located radially relative to the axis of rotation.

9. The grinding mill according to claim 7 in which each said leading wall extends between an outer end of the curved wall thereof that is connected with the outer perimeter wall of the mill shell, and an inner end of the pulp lifter segment thereof.

10. The grinding mill according to claim 7 in which each said curved wall is mounted to the discharge end wall and extends between a base portion thereof secured to the discharge end wall and an exposed edge positioned a predetermined distance from the discharge end wall, the inner edge being positioned to define a gap between the inner edge and at least one of the discharge grates that at least partially defines the pulp chambers that are also partially defined by said curved wall.

11. The grinding mill according to claim 7 additionally comprising a plurality of intermediate support elements, at least one of the support elements being located in each said pulp chamber respectively to support the discharge grate positioned to at least partially define said pulp chamber.
